(19) United States
(12) Patent Application Publication
(10) Pub. No.: US 2014/0365134 A1
(43) Pub. Date: Dec. 11, 2014

(54) Method Discriminating Between Natural And Induced Seismicity

(71) Applicants: Leo Eisner, Praha 8 (CZ); Ivo Oprsal, Senov u N. Jicína (CZ)

(72) Inventors: Leo Eisner, Praha 8 (CZ); Ivo Oprsal, Senov u N. Jicína (CZ)

(21) Appl. No.: 14/352,271

(22) PCT Filed: Jun. 29, 2012
(86) PCT No.: PCT/CZ2012/000058

§ 371 Date: Apr. 16, 2014

(51) Int. Cl. G01V 1/30; G06F 17/14; G01V 1/36

(52) U.S. Cl. CPC G01V 1/308; G01V 1/36; G06F 17/141
USPC 702/14

(57) ABSTRACT

The invention pertains generally to the field of seismicity. The method of the invention provides an objective criteria for decision when determining whether or not the seismic activity (seismicity) occurring within a certain area is induced by human activity, specifically geophysical activity, particularly associated with the mining/extracting industry, or whether the seismicity is naturally occurring. The method can be useful for production companies, regulatory authorities, or insurance companies.

### BACKGROUND OF THE INVENTION

### Field of the Invention

The invention pertains generally to the field of seismicity, and more particularly to seismic monitoring useful in the mining industry or oil and gas extraction industry. It also has applications in seismic exploration for underground water reservoirs as well as the global issue of CO₂ sequestration. Specifically, the present invention relates to the method that provides objective criteria to determine temporal association of seismicity and various types of human activity, particularly those associated with the mining industry.

It is a known fact that fluid injection or withdrawal from rock formations can induce or trigger seismic activity. However, natural seismicity also occurs in regions where the production sites are placed. The currently used methods and associated data processing lead to obtaining statistically significant correlation even for independent (random) data, indicating an incorrect causal connection where in fact no connection is present.

Proving or disproving a causal relationship between seismicity and human activity is difficult. One of the key aspects of proving a causal relationship is temporal relationships, where human activity precedes seismicity and an increase of human activity causes an increase of seismicity. Such relationship can be used by operating companies, authorities, or insurance companies to take appropriate action. The seismicity, potentially connected to the production-well treatment, may be a threat to households and infrastructure with a relatively strong societal impact.

Qualitative correlation between seismicity and injection volumes has been seen in many well documented cases of triggered or induced seismicity from fluid injection at depth (J. H. Healy, W. W. Ruby, D. T. Griggs, and C. B. Raleigh, The Denver Earthquakes, Science, Vol. 161, No. 3848, pages 1301-1310, 1968, which is hereby incorporated herein by reference). Recently, direct values of normalized cross-correlation have been used by Horton (S. Horton, Disposal of Hydrofracking Waste Fluid by Injection into Subsurface Aquifers Triggers Earthquake Swarm in Central Arkansas with Potential for Damaging Earthquake, Seismol. Res. Lett. 83(2), pages 250-260, 2012, which is hereby incorporated herein by reference). The disadvantage of such an approach is that two positive non-zero mean time series exhibit high cross-correlation values for a non-zero lag with a limit equal to 1 for large mean and low standard deviation values. Such an approach does not indicate the causal connection between the two time series.

A method that enables providing an objective determination of whether the seismic activity (seismicity) occurring within a certain area is induced or triggered by industrial mining/extraction activity or whether the seismicity is naturally occurring is strongly needed in the branch of industry. The present inventors have recently proposed (I. Oprsal and L. Eisner, Using Cross Correlation to Indicate Induced Seismicity, 2012 Seismological Society of America Annual Meeting, San Diego, Calif., 17-19 April, which is hereby incorporated herein by reference 2012) using a “useful function” by removing the running mean.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

### SUMMARY OF THE INVENTION

The present invention discloses a significant improvement to the method referenced immediately above based upon removal of the running mean and other adjustments. The inventors of the present invention have discovered how to obtain objective criteria for decision when determining whether the seismic activity (seismicity) occurring within a certain area is induced (or triggered) by human activity (e.g. geophysical treatment) associated particularly with the mining/extracting industry, such as injection or production of fluids such as brine or gas injection, or whether the recorded seismicity is naturally occurring. Hereby the term “induced” seismicity also involves the term “triggered” seismicity.

The essence of the method of the present invention lies in the providing of objective criteria to determine temporal association of seismicity and human activity. The result is given by a logical YES/NO answer to the question “are the seismicity and human activity statistically independent?” The answer is not obvious even in the case of a large amount of various data acquired during the treatment (see below), and the up-to-date scientific literature does not give a clear answer to that question. Injection into a well is not the only application. Generally, any subterranean activity such as mining, strip mining, gas production, or even a natural subterranean activity, such as a freshwater sinkhole fill, can induce seismic activity. The method of the present invention enables the distinguishing of whether seismicity is temporarily related to human technical activity (e.g. injection treatment) or to any natural process. It is based upon analyzing the seismicity measure of human activity (for example well treatment data) and upon further data processing.

Recently, the inventors have proposed (Oprsal and Eisner, 2012) a simple methodological improvement using specific treatment of the data before cross-correlation is applied with results not reliably applicable (i.e., removing running mean).

The new data acquisition and processing method described in the present application allows for statistically significant (and thus reliable) results as a basis for decision making.

The method requires an acquisition of seismic data by a monitoring system (including at least one sensor on the surface or underground), and processing the acquired data (e.g., with a computer processor). Data acquisition consists of a seismic monitoring network, which has sensors distributed at locations on the surface or subsurface and continuously records acquired seismic data. From these records, seismic events are detected, and through a process of earthquake location they can be located and their sizes (magnitudes) can be determined.

In this invention, the term “seismicity” means detected seismic events from a certain area (either located or not located). This seismicity together with some measure of human activity (e.g.

injection rate, pressure of injected fluids, etc.) is processed in two combined branches. Each of the branches (divided after human activity and seismicity data acquisition) can be used independently and can independently lead to a decision as to whether the temporal coherent seismicity is statistically related to or independent of human activities.

In an area where injection is occurring, determining the relationship between the human activity, for example geophysical treatment (quantified by injection rate, for example), and seismicity through cross-correlation is used as a tool to investigate the possibility of induced seismicity. The injection volumes, as well as the seismicity (event count), are both positive functions. While direct cross-correlation of such functions does not indicate a relationship between the two phenomena (giving high cross correlation values even for positive random functions), instead, the cross-correlation of their “effective time functions” (e.g. original functions with the weighted filtered part subtracted) is used. Normalized cross correlation (NCC) values for “effective time functions” (ETF) may peak at statistically insignificant levels of 0.5 and −0.5 for unrelated phenomena (i.e. no induced seismicity), while positive peaks above 0.5 indicate a statistically significant temporal relationship between seismicity and human activity (injection treatment).

The term “time function” means any measured and recorded discrete time history such as (injection-related) injection volumes, wellhead pressure, precipitation, seismic or co-seismic geophysical appearance of a limited choice such as a number of seismic events with magnitude larger or smaller than a given magnitude (mechanism, stress drop ,or any other parameter) in a given volume (distance, distance interval, depth interval, or any other measure); inclination, water spring discharge, geo-electric field, pore pressure, etc. The time function is a digitized discrete representation (with typically regular sampling) of an originally continuous value as a function of time.

The term “cross-correlation” is used for a calculated parameter that evaluates similarity among the time functions, the normalized cross-correlation having a peak value between −1 and 1.

A very effective tool for computing normalized cross-correlation function (NCC) can preferably be found, for example, in the MATLAB Signal Processing Toolbox (MathWorks, Natick, Mass., U.S.A., which performs signal processing, analysis, and algorithm development using computer processors in any of the Mac, Windows, and Linux computer systems) “xcorr(A,B,′coeff′)”. For using the MATLAB “xcorr” function to compute NCC, the function input discrete signals are internally normalized to have auto-correlations at zero lag equal to 1.0. The time functions have to be of the same length, or the one with a shorter non-zero part is zero padded to meet the interval, where the larger one is non-zero. The “xcorr” is different from MATLAB Statistics Toolbox's “corr” that computes correlation. The cross-correlation can be performed for complex analytical signals (where the real part is the signal, and the imaginary part is the Hilbert transform of the signal). The resulting NCC is a complex function and its absolute value can be taken as a measure of temporal correlation. Use of other cross-correlation technique implementation (such as MATLAB “corr”, from a definition of correlation coefficients of discrete signals, etc.) does not have influence on the presented method. However, some of the implementations used may differ in the resulting NCC function.

The method according to the present invention comprises some or all of the following steps:
seismic data are measured as a ground motion caused by earthquake sources by at least one sensor on the surface or underground;
processing of the seismic data enables us to detect microseismic events, in particular to detect their timing and sizes (magnitudes);
obtaining the first time function (e.g., the number of earthquakes above a certain magnitude per day in an area around the injection well) from previously obtained seismicity by processing the data in a first function module operatively associated with a computer processor resulting in earthquake source parameters (location, origin time, i.e., the time when an event occurred, the magnitude, etc.);
obtaining the second time function (e.g., injection rate) from previously obtained human activity data, e.g. geophysical treatment data, such as well head pressure, injection volumes, or mined-out volume from human technical activity which may potentially induce the seismicity in a second function module operatively associated with the computer processor;
cross-correlating time functions (TF), i.e. the first time function and the second time function in a first cross-correlation module operatively associated with the computer processor, to obtain normalized cross-correlation (NCC_{TF}) and normalizing the result with a special normalization coefficient (i.e. theoretically expected NCC, NCC_{TE}) derived from the time functions themselves in a special normalization module operatively associated with the computer processor to obtain a newly renormalized cross-correlation (RNCC);
alternatively (or additionally, see further) applying a mathematical transformation to the first time function and to the second time function in a mathematical transformation module operatively associated with the computer processor to enhance significant temporal variations to obtain effective time functions (ETF), i.e. the first effective time function and the second effective time function, wherein the time functions can be transformed in several possible ways;
cross-correlating the first effective time function and the second effective time function in a second cross-correlation module operatively associated with the computer processor and obtaining normalized cross-correlation (NCC_{ETF}) that discriminates temporal resemblance of effective time functions;
estimating whether the above obtained cross-correlation (NCC_{ETF} or RNCC) peaks at significantly high value with small temporal delay between the two time functions (i.e., the first effective time function and the second effective time function or the first time function and the second time function), which is indicative that the two are related, in a statistical significance determination module operatively associated with the computer processor.

Furthermore, the technique based upon cross-correlating time functions (resulting in RNCC) can be combined with the technique based upon cross-correlating effective time functions (resulting in NCC_{ETF}) in the way that both cross-correlations are assessed and used for assessing the probability of induced seismicity. This combination enhances the predictive strength of the method.

The preferred way to obtain ETF is by transforming the TF into Fourier spectral domain by discrete Fourier transformation (see, e.g., U.S. Pat. No. 6,714,867, to Meunier, which is hereby incorporated herein by reference), multiplying the real and imaginary part of it by a filtering function (FF) and transforming the result back into time domain to obtain ETF. For some specific cases, the ETF can be created by subtracting the mean value from a function. This is known as the Pearson's test. Some other examples of other constructions of the ETF's are:
High-pass, low-pass, or band-pass filtration of a signal in the Fourier domain by an arbitrary filter;
Low-pass filtration of a signal in the time domain by subtracting running window average, wherein the window time span depends on time and it can be weighted with weight dependent on time.

Network geometry for measuring the seismic data should be designed to meet the IASPEI manual of observatory practice demands. The basic parameters of such a network are the distance between receivers in the monitoring network (and their associated sensors) and geometry. Data of present regional stations can be used.

A person skilled in the art will understand that various modifications may be made in the invention without departing from the scope of the invention as described in this text and set forth in the appended claims.

### DESCRIPTION OF THE DRAWINGS

The present invention will be further described, by way of example, with references to the drawings, in which:

FIG. 1 is a normalized cross-correlation of two random functions, representing weekly data number of earthquakes above magnitude 2 per week, with the normalized mean and standard variations decreasing due to summation for weekly intervals, and the cross-correlation plateau value being as shown in Equation 2;

FIG. 2 is Pearson's cross-correlation of weekly data as presented in FIG. 1, with the mean values of the non-zero-padded parts subtracted before computing the normalized correlation, wherein for longer series or more realizations (in terms of average), the correlation limits to 0 for independent variables;

FIG. 3 is the NCC_{ETF} (bottom panel) for “effective time functions” (ETF) of Number of earthquakes larger than given magnitude per month at the Rocky Mountain Arsenal waste injection (upper panel), and Injected volume per month (lower panel) (data for ETF's taken from Healy et al, 1968), wherein ETF's are created by filtering in the frequency domain with filter=(1−0.85*Sinc(f)), where f=4.8*(1e−8) Hz;

FIG. 4 is the RNCC (bottom panel) for original time functions: Number of earthquakes at the Rocky Mountain Arsenal waste injection (upper panel), and injected volume (lower panel) (data of two upper panels taken from Healy et al, 1968); and

FIG. 5 is a flowchart describing the method from data acquisition to decision on statistically significant correlation between geophysical activity and related seismicity, wherein the two possible processes, which can be taken independently, work with A: original data (left panel), and B: filtered data, respectively, and wherein A: performs the NCC on original data and normalizes it to RNCC for time functions, and B: is based on filtering the data to effective time functions and performing the NCC estimation resulting in NCC_{ETF}.

### DETAILED DESCRIPTION OF THE EXEMPLARY EMBODIMENT

The following example provides exemplary embodiment(s) and is not intended to limit the scope, applicability or configuration of the invention.

1. Theoretical considerations.

Let us investigate the normalized cross-correlation of time functions A and B with non-zero means:

A=N_{A}+μ_{A},

B=N_{B}+μ_{B}

where N_{A} is a function of zero mean, μ_{A}.is mean of A, and the respective standard deviation reads:

E(N_{A}²)=σ_{A}²,

E(N_{A})=0.

E(X) is the expected value of X. (Values of B, and B-indexed values apply by analogy). There are plenty of definitions of cross-correlation. The normalized cross-correlation (as in the MATLAB Signal Processing Toolbox, or “reflective correlation,” Wikipedia), NCC, reads:

$$\begin{matrix}{Corr}_{n} ( A , B ) = \frac{E ( AB )}{\sqrt{E ( {A}^{2} ) E ( {B}^{2} )}} \\ = \frac{E ( ( {N}_{A} + {μ}_{A} ) ( {N}_{B} + {μ}_{B} ) )}{\sqrt{E ( {( {N}_{A} + {μ}_{A} )}^{2} ) E ( {( {N}_{B} + {μ}_{B} )}^{2} )}} \\ = \frac{E ( {N}_{A} {N}_{B} ) + {μ}_{A} {μ}_{B}}{\sqrt{( {σ}_{A}^{2} + {μ}_{A}^{2} ) ( {σ}_{B}^{2} + {μ}_{B}^{2} )}}\end{matrix} \qquad ( 1 )$$

For independent random functions N_{A}, N_{B}, theoretically expected cross-correlation can be calculated as follows:

$$\frac{{μ}_{A} {μ}_{B}}{\sqrt{( {σ}_{A}^{2} + {μ}_{A}^{2} ) ( {σ}_{B}^{2} + {μ}_{B}^{2} )}} = {NCC}_{TE} ( A , B ) \qquad ( 2 )$$

Therefore for two functions with a non-zero mean, the smaller the deviation around that mean, the higher the cross-correlation (assuming both means have the same signs).

Hence renormalized cross-correlation, RNCC, is defined as:

$$RNCC ( A , B ) = \frac{{Corr}_{n} ( A , B ) - {NCC}_{TE} ( A , B )}{1 - {NCC}_{TE} ( A , B )} , \qquad ( 3 )$$

Wherein the denominator re-normalizes maximum value to 1 for perfectly correlated functions.

For time functions with relatively small σA and σB and independent functions N_{A}, N_{B}:

$${lim}_{\frac{{σ}_{A}}{{μ}_{A}} , \frac{{σ}_{B}}{{μ}_{B}} \to 0 ,} ( \frac{{μ}_{A} {μ}_{B}}{\sqrt{( {σ}_{A}^{2} + {μ}_{A}^{2} ) ( {σ}_{B}^{2} + {μ}_{B}^{2} )}} ) = 1 \qquad ( 4 )$$

For time functions with μ_{A}=μ_{B}=0:

$${Corr}_{{n}_{zeromeans}} ( A , B ) = \frac{E ( {N}_{A} {N}_{B} )}{{σ}_{A}^{2} {σ}_{B}^{2}} \qquad ( 5 )$$

Only in this case, the normalized cross-correlation ranges between −1 and +1 and may indicate a physical relationship if it is close to 1.

MATLAB Statistics Toolbox (The MathWorks, Inc., Natick, Mass., MA 01760-2098, U.S.A.)

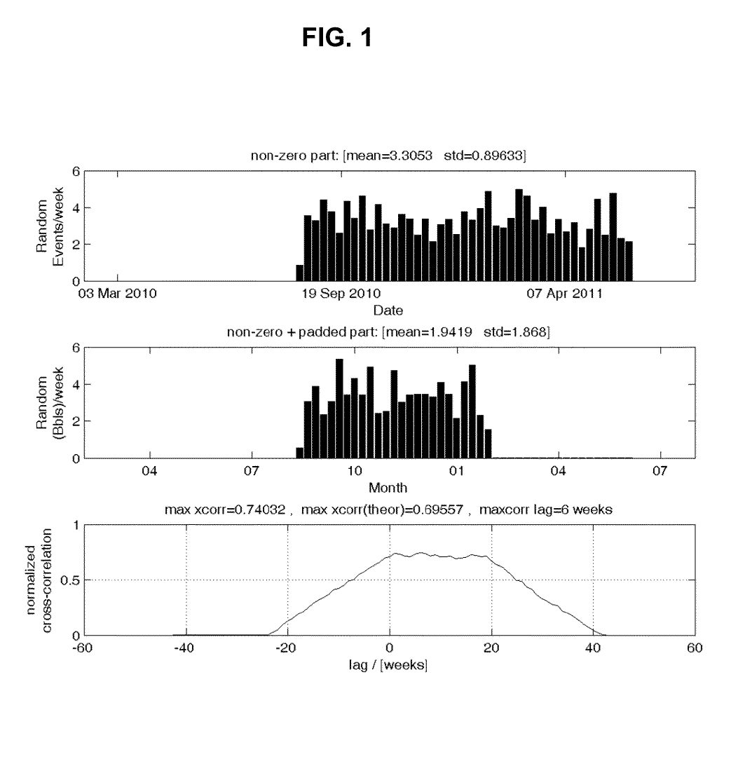

was used as a preferred mathematical tool. It is to note that “xcorr” is different from MATLAB Statistics Toolbox's ‘corr’ that computes correlation specified in Equation (4). The NCC function from the MATLAB Signal Processing Toolbox “xcorr(A,B,′coeff′)” is used. Hence the respective σ and μ apply to the longer of the intervals for both inputs. Equations (1, 2) and (4, 5), giving a value of maximum (or plateau) of the cross-correlation, are valid in the sense of average of realizations or infinite signal limit, being an estimate for current realization of independent functions (see FIG. 1). The theoretical value of NCC, NCC_{TE} (Equation 2, “max_xcross(theor)” value in all figures) is computed for every signal on presumption of independent series (E(AB)=0). FIG. 1 shows random function with non-zero means, and their NCC. The random realization of these two variables is exactly the same, but the statistical features of the latter are computed including the zero-padded interval as in MATLAB. The plateau amplitude is consistent (in average) with the theoretically obtained value of the normalized cross-correlation. If the functions had equal length, the envelope of NCC would be a triangle.

In this case, the NCC is a trapezoid with its maximum amplitude decreased due to normalization. Note the change of the mean value and the standard deviation of the second plot of FIG. 1 signal from non-zero part expected μ˜1/2 and √(1/12)=0.289 due to zero-padding and normalization. The series of FIG. 1 are “weekly” values, where each of these values is created by summation of seven random realizations of two positive (daily values), random functions with boxcar distribution in <0,1>(μ=1/2). If normalized, then the mean value of their non-zero parts would remain unchanged while their standard deviation would decrease to √(1/7 1/12)=0.109 following the Central limit theorem.

### 2. Application.

a) Original-data processing.

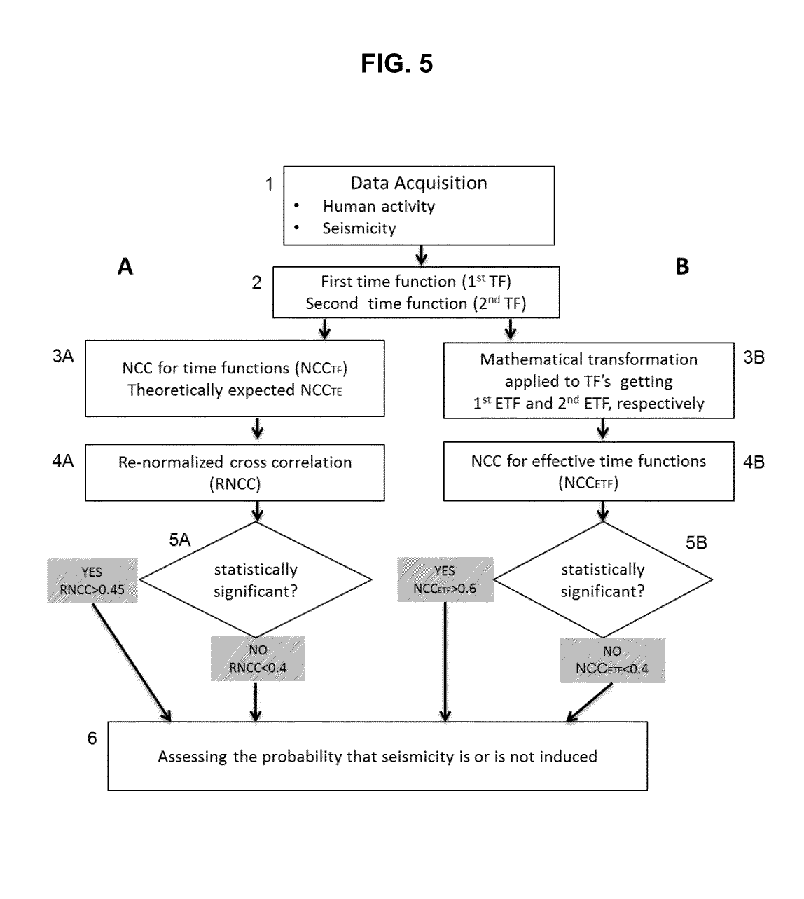

The first branch of the method comprising steps 1, 2, 3A-5A, and 6 (FIG. 5) is showing how to treat the non-preprocessed data in the decision process. It is normalization of the NCC of the original time functions normalized to the theoretically expected NCC of independent time functions, NCC_{TE}. The resulting newly-normalized cross-correlation for the time function RNCC is given in Equation 3, wherein the NCC for time functions, NCC_{TF}, is estimated according to Equation 1, and the expected NCC, NCC_{TE}, is estimated according to Equation 2.

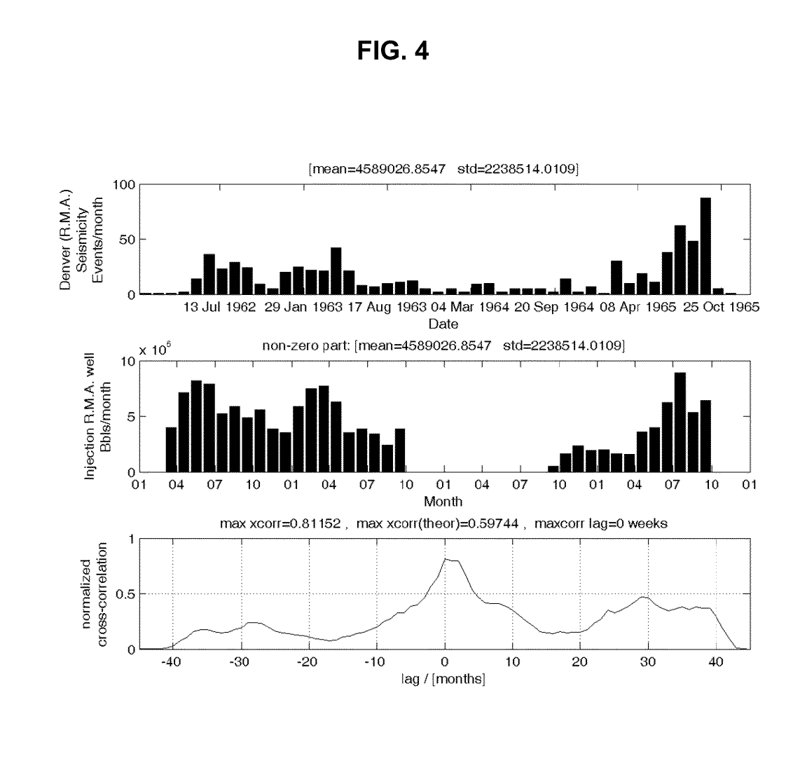

The result given in Equation 3 is not obvious because the NCC for random time functions (FIG. 1), and the NCC for induced seismicity and injected volumes (FIG. 4) give statistically significant values of the NCC peaks 0.764 and 0.81, respectively, without a possibility to distinguish between these two cases. Re-normalizing the theoretically expected values and the computed NCC give (again for cases in FIGS. 1 and 4, respectively) value RNCC=0.136 for random functions (i.e. seismicity is not induced by human technical activity) and RNCC=0.533 for the induced-seismicity case.

### b) Transformed-Data Processing.

Another branch of the procedure comprising the steps 1, 2, 3B-5B, and 6 (FIG. 5) deals with the time functions that are transformed into effective time functions (ETF) (effective time variations) before the cross-correlation is performed. Normalized cross correlation of the ETF's is computed from Equation (1) resulting in the NCC_{ETF}.

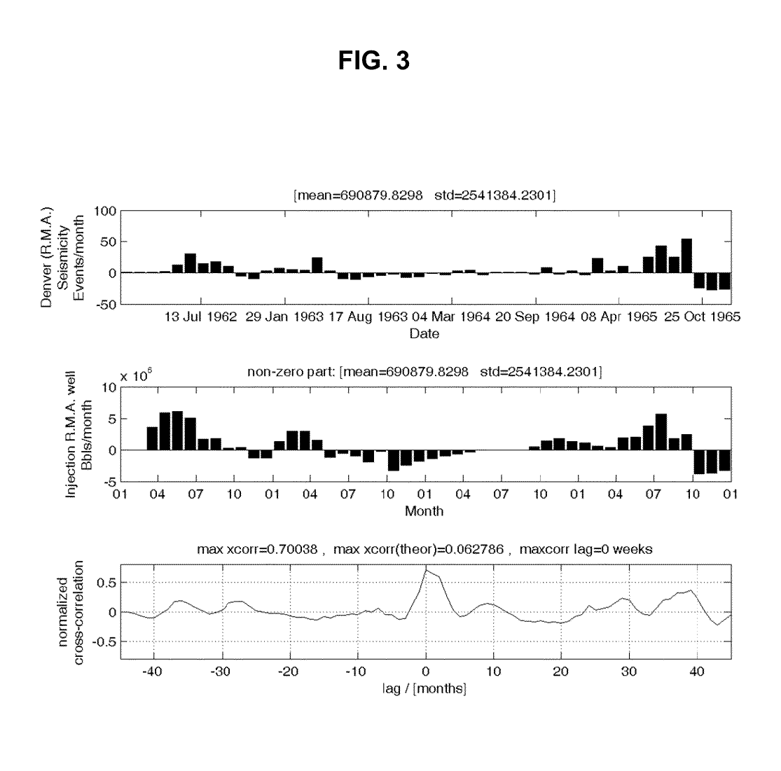

We have found that most effective way to obtain the ETF is transforming the signal into the Fourier spectral domain by discrete Fourier transformation, multiplying the real and imaginary part of it by a filtering function FF, and transforming the result back into time domain to obtain the ETF. The example in FIG. 3 shows a single-peak NCC function. The unique peak means that there is only one possible time shift (here approximately zero) to match the ETF's. The single-peak value=0.7 gives a strong indication that the seismicity is induced by the human activity, e.g. geophysical treatment such as production-well treatment.

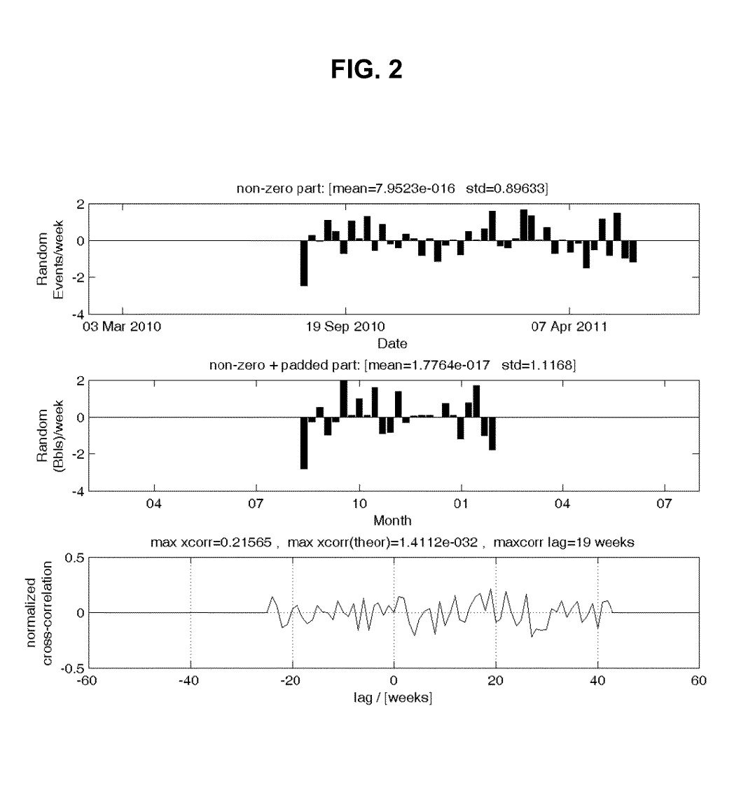

For some purely random signals with stationary time-windowing statistics, such as a constant time-dependent deviation (not being a typical earthquake activity case), the ETF can be created by subtracting the mean value from a function. This is known as Pearson's test. FIG. 2 shows Pearson's test of FIG. 1 data (or the cross-correlation of the ETF's of FIG. 1 data) with a very low NCC (0.21), which would be significantly lower for longer time series or an average of multiple random realizations. Some examples of other constructions of the “effective time functions” are:
high-pass, low-pass, or band-pass filtration of a signal in the Fourier domain by an arbitrary filter;
low-pass filtration of a signal in the time domain by subtracting the running window average, wherein the window time span depends upon time, and can be weighted with a weight that is dependent upon time.

If the seismicity present within human activity time span is induced, then the NCC_{ETF} has a global maximum at approximately zero time corresponding to a short time lag between the two time functions. The value of the global maximum is above statistical significance (i.e. above 0.5), and it is positive. Cross-correlation without such features implies that the seismicity is not related to the human activity.

### c) Decision Process.

After knowing the final results of the A-branch (FIG. 5, step 5A) and/or the B-branch (FIG. 5, step 5B), the decision in form of “seismicity is not induced” or “seismicity is probably induced” can be made. The decision is based upon statistical independence of the time functions as depicted in the bottom parts of the flow chart in FIG. 5. The most suitable threshold values for a YES/NO decision which we have found are approximately 0.45 for the A-branch process and approximately 0.60 for the B-branch process.

The decision threshold values are based upon empirical knowledge; as such, they were calibrated on the time functions of the human-induced seismicity and the natural seismicity known from prior art. The person skilled in the art is aware of the fact that the present threshold values are region-dependent, and thus are demonstrated as preferred values in the specific examples. The skilled person also knows the routine approach of how to test/calibrate the threshold values, which is useful for realization of the present invention. The same applies to the final decisions, which are influenced by the current knowledge of pertinent geophysical processes and by obtained data accuracy. Hence the skilled person is aware that a final answer that “Seismicity is induced” is not given with 100% probability.

Both process branches A and B can be used jointly to provide a combined statistical significance decision (FIG. 5). There are ten possible combinations of answers from branches A and B:

| Answer from | Answer from | |
|---|---|---|
| branch A | branch B | Final (combined) decision |
| YES | YES | “Seismicity IS induced” |
| un- | YES | “Seismicity IS probably induced” |
| determined | | |
| YES | un- | “Seismicity IS probably induced” |
| | determined | |
| un- | NO | “Seismicity IS NOT probably induced” |
| determined | | |
| NO | un- | “Seismicity IS NOT probably induced” |
| | determined | |
| YES | NO | “Probable cause of seismicity is unclear” |
| NO | YES | “Probable cause of seismicity is unclear” |
| NO | NO | “Seismicity IS NOT induced” |
| YES | NO | “Probable cause of seismicity is unclear” |
| NO | YES | “Probable cause of seismicity is unclear” |

The answers then determine whether the seismicity is probably induced, probably not induced, or that the relationship is not statistically significant. The term “undetermined” stands for situations in FIG. 5, steps 5A or 5B, when statistical significance is between two threshold values for “YES” and “NO” answers, respectively.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be claimed alone or in combination with any of the features, elements, or components of any of the other embodiments discussed above.

### REFERENCES

Healy, J. H., W. W. Rubey, D. T. Griggs, and C. B. Raleigh, The Denver Earthquakes (Science, Vol. 161 , No. 3848, pages 1301-1310, 1968).
Horton, S., Disposal of Hydrofracking Waste Fluid by Injection into Subsurface Aquifers Triggers Earthquake Swarm in Central Arkansas with Potential for Damaging Earthquake (Seismol. Res. Lett. 83(2), pages 250-260, 2012).
Oprsal, I., and Eisner, L., Using Cross Correlation to Indicate Induced Seismicity, (2012 Seismological Society of America Annual Meeting, San Diego, Calif., 17-19 April, 2012).
U.S. Pat. No. 6,714,867, to Meunier.

1. A method for discriminating between natural and induced seismicity comprising:
acquiring human activity data and acquiring seismicity data with at least one sensor in a monitoring system for the same location and time period;
processing the human activity data and the seismicity data with first and second function modules, respectively, to transform them into a first time function and a second time function, respectively;
determining a normalized cross-correlation, NCC_{TF}, between the first time function and the second time function with a first cross-correlation module;
determining renormalized cross-correlation, RNCC, in a special normalization module on the basis of theoretically expected normalized cross-correlation, NCC_{TE}.
assessing the statistical significance of RNCC in a statistical significance determination module; and
providing as an output of the statistical significance determination module the probability of whether or not seismicity is induced by the human activity on the basis of statistical significance of RNCC;
wherein at least one processor device is operatively associated with at least one of the first and second function modules, the first cross-correlation module, the special normalization module, and the statistical significance determination module.

2. The method according to claim 1, characterized in that it additionally comprises:
obtaining a first effective time function and a second effective time function from the first time function and the second time function, respectively, by applying mathematical transformations to the first time function and the second time function in a mathematical transformation module;
determining the normalized cross-correlation, NCC_{ETF}, between the first effective time function and the second effective time function with a second cross-correlation module;
assessing the statistical significance of NCC_{ETF} in the statistical significance determination module; and
providing as an output of the statistical significance determination module the probability of whether or not seismicity is induced by the human activity on the basis of statistical significance of RNCC in combination with statistical significance of NCC_{ETF}.

3. The method for discriminating between natural and induced seismicity comprising:
acquiring human activity data and acquiring seismicity data with at least one sensor in a monitoring system for the same location and time period;
processing the human activity data and the seismicity data with first and second function modules, respectively, to transform them into a first time function and a second time function, respectively;
obtaining a first effective time function and a second effective time function from the first time function and the second time function, respectively, by applying mathematical transformations to the first time function and the second time function in a mathematical transformation module;
determining the normalized cross-correlation, NCC_{ETF}, between the first effective time function and the second effective time function with a second cross-correlation module;
assessing the statistical significance of NCC_{ETF} in a statistical significance determination module; and
providing as an output of the statistical significance determination module the probability that seismicity is induced by the human activity on the basis of statistical significance of NCC_{ETF};
wherein at least one processor device is operatively associated with at least one of the first and second function modules, the mathematical transformation module, the second cross-correlation module, and the statistical significance determination module.

4. (canceled)

5. The method according to claim 3, characterized in that the mathematical transformation is selected from the following methods or their equivalents:
transforming the time function into Fourier spectral domain by discrete Fourier transformation, multiplying the real and imaginary part of it by a filtering function and transforming the result back into time, domain;
subtracting the mean value from a function;
high-pass, low-pass or band-pass filtrating of a function in the Fourier domain by arbitrary filter; and
low-pass filtrating of a function in the time domain by subtracting running window average, optionally using weighted window time span with weight dependent on time.

6. The method according to claim 2, characterized in that the mathematical transformation is selected from the following methods or their equivalents:
transforming the time function into Fourier spectral domain by discrete Fourier transformation, multiplying the real and imaginary part of it by a filtering function and transforming the result back into time domain;
subtracting the mean value from a function;
high-pass, low-pass or band-pass filtrating of a function in the Fourier domain by arbitrary filter; and
low-pass filtrating of a function in the time domain by subtracting running window average, optionally using weighted window time span with weight dependent on time.

7. A monitoring system for discriminating between natural and induced seismicity, comprising:
at least one processor device;
at least one sensor that acquires human activity data and seismicity data for the same location and time period;
a first function module operatively associated with the at least one processor device, wherein the first function module processes the human activity data to transform it into a first time function;
a second function module operatively associated with the at least one processor device, wherein the second function module processes the seismicity data to transform it into a second time function;
a first cross-correlation module operatively associated with the at least one processor device, wherein the first cross-correlation module determines a normalized cross cross-correlation, NCC_{TF}, between the first time function and the second time function;
a special normalization module operatively associated with the at least one processor device, wherein the special normalization module determines renormalized cross-correlation, RNCC, on the basis of theoretically expected normalized cross cross-correlation, NCC_{TE}; and
a statistical significance determination module operatively associated with the at least one processor device, wherein the statistical significance determination module assesses the statistical significance of RNCC, wherein the statistical significance of RNCC is indicative of the probability of whether or not seismicity is induced by the human activity.

8. A monitoring system as defined in claim 7, additionally comprising:
a mathematical transformation module operatively associated with the at least one processor device, wherein the mathematical transformation module obtains a first effective time function and a second effective time function from the first time function and the second time function, respectively, by applying mathematical transformations to the first time function and the second time function; and
a second cross-correlation module operatively associated with the at least one processor device, wherein the second cross-correlation module determines the normalized cross cross-correlation, NCC_{ETF}, between the first effective time function and the second effective time function;
wherein the statistical significance determination module assesses the statistical significance of NCC_{ETF} and provides as an output the probability of whether or not seismicity is induced by the human activity on the basis of statistical significance of RNCC in combination with statistical significance of NCC_{ETF}.

9. A monitoring system as defined in claim 8, wherein the mathematical transformation module transforms the time function into Fourier spectral domain by discrete Fourier transformation, multiplies the real and imaginary part of it by a filtering function and transforms the result back into time domain, subtracts the mean value from a function, high-pass, low-pass, or band-pass filters a function in the Fourier domain by arbitrary filter, and low-pass filters a function in the time domain by subtracting running window average, optionally using weighted window time span with weight dependent on time.
